(19) United States
(12) Patent Application Publication
(10) Pub. No.: US 2014/0078665 A1
(43) Pub. Date: Mar. 20, 2014

(54) DATA STORAGE DEVICE ASSEMBLY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: XIANG YU, Shenzhen (CN); XIAO-YONG MA, Shenzhen (CN)

(21) Appl. No.: 13/913,456

(22) Filed: Jun. 9, 2013

(30) Foreign Application Priority Data
Sep. 14, 2012 (CN) 2012103405369

(51) Int. Cl. G06F 1/18

(52) U.S. Cl. CPC G06F 1/187
USPC 361/679.33

(57) ABSTRACT

A data storage device assembly includes a data storage device and a bracket. The bracket includes a bottom frame, a locking portion and an installation portion. The locking portion includes a first limiting piece and a stopping tab, and the installation portion includes a second limiting piece, a pressing portion and a latch portion. The data storage device is positioned on the bottom frame and sandwiched between the first limiting piece and the second limiting piece. The latch portion is engaged with the stopping tab to abut the pressing portion with the data storage device, to be easily assembled in the bracket.

### BACKGROUND

1. Technical Field

The present disclosure relates to data storage device assemblies, and particularly to a data storage device assembly having a data storage device easily to be installed on a bracket.

2. Description of Related Art

Computers typically include a CD-driver. The CD-driver is secured to a bracket with screws, and the CD-driver and the bracket are then installed on the computer with screws. Assembly or disassembly of the CD-driver is very time-consuming and inconvenient. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a data storage device assembly in accordance with an embodiment, the data storage device assembly including a bracket and a data storage device.

FIG. 2 is an isometric view of the data storage device of FIG. 1.

FIG. 3 is an assembled view of the data storage device assembly of FIG. 1.

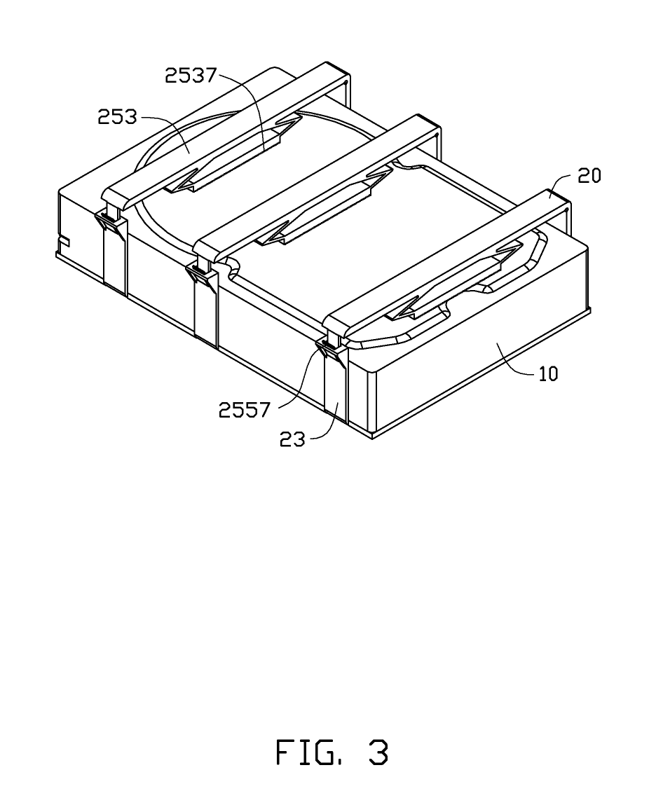

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

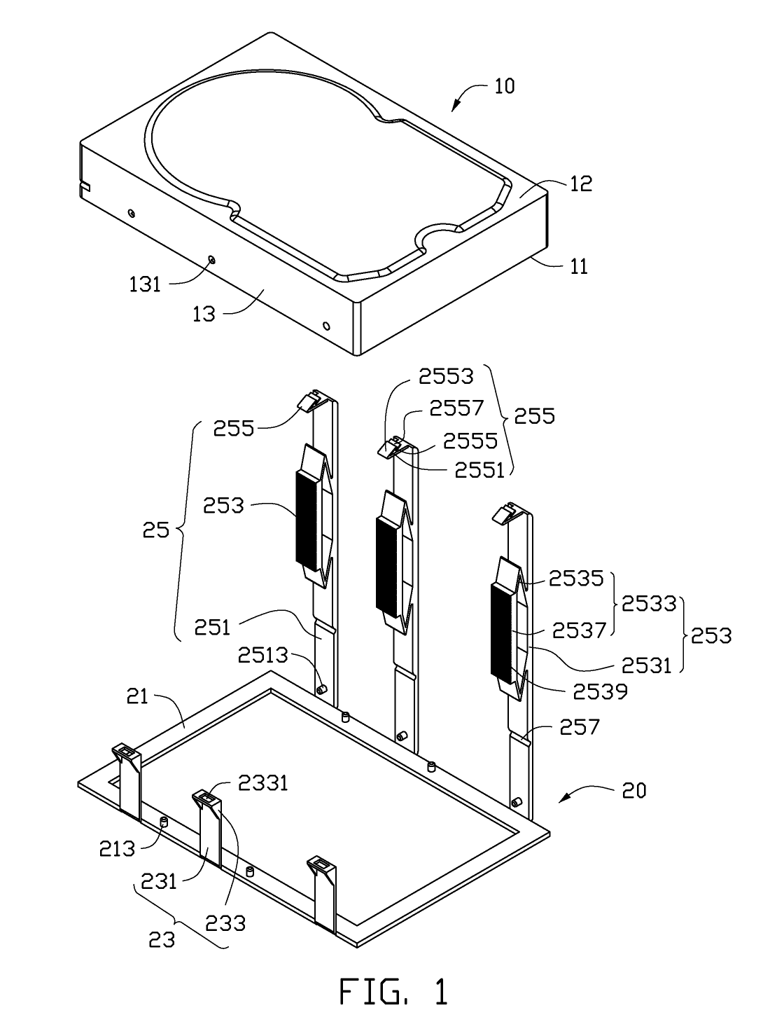

FIG. 1 is a data storage device assembly of an embodiment. The data storage device assembly includes a data storage device 10 and a bracket 20. In one embodiment, the data storage device 10 may be a CD-driver, for example.

The data storage device 10 includes a bottom wall 11, a top wall 12 opposite to the bottom wall 11, and two sidewalls 13. The two sidewalls 13 extend from opposite sides of the bottom wall 11. The two sidewalls 13 are substantially parallel to each other and perpendicular to the bottom wall 11. Four positioning holes 111 are defined in the bottom wall 11. In one embodiment, the four positioning holes 111 are arranged at four corners of a rectangle defined in the bottom wall 11. Three engaging holes 131 are defined in each of the two sidewalls 13 corresponding to the bracket 20.

The bracket 20 includes a bottom frame 21, three locking portions 23, and three installation portions 25, corresponding to the three locking portions 23. Four positioning posts 213 protrude from the bottom frame 21, corresponding to the four positioning holes 111. The three locking portions 23 and the three installation portions 25 are located on two opposite edges of the bottom frame 21.

Each of the three locking portions 23 is aligned in a same line with each of the three installation portions 25. Each of the three locking portions 23 includes a first limiting piece 231 and a stopping tab 233. The first limiting piece 231 perpendicularly extends from the bottom frame 21. The stopping tab 233 extends outwards from a distal end of the first limiting piece 231. The stopping tab 233 is substantially perpendicular to the first limiting piece 231 and defines a stopping hole 2331 for engaging with each of the three installation portions 25.

Each of the three installation portions 25 includes a second limiting piece 251, a pressing portion 253, and a latch portion 255. The second limiting piece 251 extends substantially perpendicularly from the bottom frame 21 and substantially parallel to the first limiting piece 231. An engaging post 2513 protrudes from each second limiting piece 251 and each first limiting piece 231 corresponding to each of the three engaging holes 131 of the two sidewalls 13. A recess 257 is defined in a joint of each pressing portion 253 and each second limiting piece 251. The pressing portion 253 is rotatable relative to the second limiting piece 251 at the joint.

The pressing portion 253 includes a pressing piece 2531 and a pressing body 2533 located on the pressing piece 2531. The pressing body 2533 includes two resilient portions 2535 and a pressing block 2537, connected to the two resilient portions 2535. A plurality of teeth 2539 are located on outer surface of the pressing block 2537, for contacting with the data storage device 10. In one embodiment, each of the two resilient portions 2535 is substantially V-shaped.

The latch portion 255 includes an extension tab 2551, a guiding tab 2553, a latch tab 2555, and an operating tab 2557. The extension tab 2551 perpendicularly extends from each pressing piece 2531. The guiding tab 2553 reversely extends from a distal end of the extension tab 2551, and a first acute angle is defined between the guiding tab 2553 and the extension tab 2551. The latch tab 2555 extends downwards from a distal end of the guiding tab 2553 and substantially perpendicular to the extension tab 2551. A second acute angle is defined between the latch tab 2555 and the guiding tab 2553. The operating tab 2557 obliquely extends from the latch tab 2555 and substantially parallel to the guiding tab 2553.

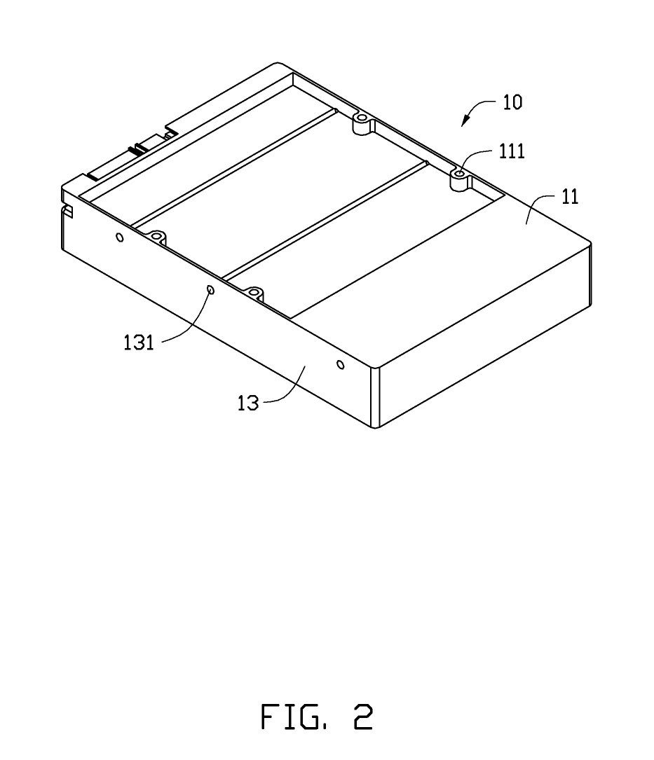

FIG.S shows that in assembly, the data storage device 10 is placed on the bottom frame 21 of the bracket 20. Each positioning post 213 is engaged in each positioning hole 111(shown in FIG. 2), for preventing the data storage device 10 from moving along a first direction that is parallel to the bottom frame 21. Each first limiting piece 231 is resiliently pulled to engage each engaging post 2513 into each engaging hole 131, and the data storage device 10 is thereby located between each first limiting piece 231 and each second limiting piece 251. Each pressing portion 253 is rotated to be close to each stopping tab 233 and aligns each latch portion 255 with each stopping hole 2331. Each guiding tab 2553 is squeezed to be resiliently deformed, until each guiding tab 2553 extends through the stopping hole 2331. Each guiding tab 2553 resiliently rebounds to engage the latch tab 2555 with an edge of each stopping hole 2331. The pressing body 2533 resists the top wall 12 of the data storage device 10, for preventing the data storage device 10 from moving along a second direction that is perpendicular to the bottom frame 21. The data storage device 10 is thereby installed on the bracket 20.

In assembly of the data storage device 10, each operating tab 2557 is pressed to disengage each latch tab 2555 from each stopping hole 2331, and each pressing portion 253 is rotated away from the data storage device 10. The data storage device 10 is thereby easily detached from the bracket 20.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A data storage device assembly comprising:
a data storage device; and
a bracket comprising a bottom frame, a locking portion, and an installation portion located on the bottom frame; the locking portion comprises a first limiting piece and a stopping tab located on the first limiting piece; the installation portion comprises a second limiting piece, a pressing portion located on the second limiting piece, and a latch portion located on the pressing portion; the data storage device is located between the first limiting piece and the second limiting piece, and the latch portion is engaged with the stopping tab, for preventing the data storage device from moving along a direction perpendicular to the bottom frame.

2. The data storage device assembly of claim 1, wherein the stopping tab defines a stopping hole; the latch portion comprises a guiding tab and a latch tab located on the guiding tab; the latch tab is engaged with an edge of the stopping hole; and the guiding tab is resilient deformed to disengage the latch tab from the stopping hole.

3. The data storage device assembly of claim 2, wherein the latch portion further comprises an extension tab; the extension tab extends from the pressing portion, the guiding tab extends from the extension tab, and the latch tab extends from the guiding tab.

4. The data storage device assembly of claim 3, wherein the pressing portion comprises a pressing piece, and the extension tab is substantially perpendicular to the pressing piece.

5. The data storage device assembly of claim 3, wherein a first acute angle is defined between the guiding tab and the extension tab, a second acute angle is defined between the guiding tab and the latch tab, and the latch tab is substantially perpendicular to the extension tab.

6. The data storage device assembly of claim 4, wherein the pressing portion further comprises a pressing body located on the pressing piece; the pressing body comprises two resilient portions and a pressing block connected to the two resilient portions; and the pressing block abuts the data storage device.

7. The data storage device assembly of claim 6, wherein each of the two resilient portions is substantially V-shaped.

8. The data storage device assembly of claim 6, wherein a plurality of teeth is located on the pressing block.

9. The data storage device assembly of claim 1, wherein a recess is defined in a joint of the second limiting piece and the pressing portion, and the pressing portion is rotatable relative to the second limiting piece at the joint.

10. The data storage device assembly of claim 1, wherein a positioning post is located on the bottom frame, the data storage device defines a positioning hole corresponding to the positioning post, and the positioning post is engaged in the positioning hole, for preventing the data storage device from moving in a plane which is parallel to the bottom frame.

11. A data storage device assembly comprising:
a data storage device comprising a bottom wall, and the bottom wall defining a positioning hole; and
a bracket comprising a bottom frame, a locking portion and an installation portion located on opposite sides of the bottom frame; a positioning post located on the bottom frame, the locking portion comprising a first limiting piece and a stopping tab located on the first limiting piece, the installation portion comprising a second limiting piece, a pressing portion located on the second limiting piece, and a latch portion located on the pressing portion; the data storage device being located between the first limiting piece and the second limiting piece, the positioning post being engaged in the positioning hole, for preventing the data storage device from moving in a plane which is parallel to the bottom frame, and the latch portion is engaged with the stopping tab, for preventing the data storage device from moving along a direction perpendicular to the bottom frame.

12. The data storage device assembly of claim 11, wherein the stopping tab defines a stopping hole; the latch portion comprises a guiding tab and a latch tab located on the guiding tab; the latch tab is engage with an edge of the stopping hole, and the guiding tab is resilient deformed to disengage the latch tab from the stopping hole.

13. The data storage device assembly of claim 12, wherein the latch portion further comprises an extension tab; the extension tab extends from the pressing portion, the guiding tab extends from the extension tab, and the latch tab extends from the guiding tab.

14. The data storage device assembly of claim 13, wherein the pressing portion comprises a pressing piece, and the extension tab is substantially perpendicular connected to the pressing piece.

15. The data storage device assembly of claim 13, wherein a first acute angle is defined between the guiding tab and the extension tab, a second acute angle is defined between the guiding tab and the latch tab, and the latch tab is substantially perpendicular to the extension tab.

16. The data storage device assembly of claim 14, wherein the pressing portion further comprises a pressing body located on the pressing piece; the pressing body comprises two resilient portions and a pressing block connected to the two resilient portions; and the pressing block abuts the data storage device.

17. The data storage device assembly of claim 16, wherein each of the two resilient portions is substantially V-shaped.

18. The data storage device assembly of claim 16, wherein a plurality of teeth is located on the pressing block.

19. The data storage device assembly of claim 11, wherein a recess is defined in a joint of the second limiting piece and the pressing portion, and the pressing portion is rotatable relative to the second limiting piece at the joint.

20. The data storage device assembly of claim 11, wherein the data storage device further comprises two sidewalls located on the bottom wall, an engaging hole is defined in each of the two sidewalls, an engaging post is located on each of the first limiting piece and the second limiting piece, and each engaging post is engaged in each engaging hole.
